(19) United States
(12) Patent Application Publication
(10) Pub. No.: US 2010/0225439 A1
(43) Pub. Date: Sep. 9, 2010

(54) ARRAY RESISTOR AND METHOD OF FABRICATING THE SAME

(75) Inventors: Seongchan Han, Cheonan-si (KR); Jaeyoung Kim, Suwon-si (KR); Kwangsu Yu, Cheonan-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/709,697

(22) Filed: Feb. 22, 2010

(30) Foreign Application Priority Data
Feb. 20, 2009 (KR) 2009-14455

(51) Int. Cl. H01C 1/012

(52) U.S. Cl. 338/309

(57) ABSTRACT

An array resistor may include a body, a first resistor, and a second resistor. The body may have a front surface, a rear surface opposite to the front surface, and side surfaces connecting the front surface and the rear surface. The first resistor may be disposed on the front surface, the first side surface, and the second side surface opposite to the first side surface. The second resistor may be disposed on the rear surface, the third side surface, and the fourth side surface opposite to the third side surface.

### CROSS-REFERENCE TO RELATED APPLICATIONS

This U.S. non-provisional patent application claims priority under 35 U.S.C. §119 of Korean Patent Application No. 10-2009-0014455, filed on Feb. 20, 2009, the entire contents of which are hereby incorporated by reference.

### BACKGROUND

1. Field of the Invention

The present disclosure relates to an array resistor, and more particularly, to an array resistor with an increased integration density and a method of fabricating the same.

2. Description of the Related Art

In general, electronic devices are mounted with various surface mount type units. For example, surface mount units include varistor devices and chip network resistors. The varistor device includes a resistor-varistor complex chip and an inductor-varistor complex chip. The resistor-varistor complex chip and the inductor-varistor complex chip have resistors, inductors, and varistors that are selectively mounted on a body. The body of the varistor device has a stack of dielectric substrates. The varistor device is fabricated by forming a metal interconnection and a resistor line on each of the dielectric substrates and coupling the dielectric substrates together. On the other hand, the chip network resistor (also called an array resistor) has a plurality of resistors on a body in order to increase the integration density of an electronic device. The body of the array resistor includes one dielectric substrate, and the resistors are disposed on the surface of the resistors.

### SUMMARY

Embodiments of the present general inventive concept provide an array resistor with an increased integration density and a method of fabricating the same.

Additional aspects and utilities of the present general inventive concept will be set forth in part in the description which follows and, in part, will be obvious from the description, or may be learned by practice of the general inventive concept.

Features and/or utilities of the present general inventive concept may be realized by an array resistor including a body having a front surface, a rear surface opposite to the front surface, and side surfaces connecting the front surface and the rear surface, a first resistor disposed on the front surface, the first side surface, and the second side surface opposite to the first side surface, and a second resistor disposed on the rear surface, the third side surface, and the fourth side surface opposite to the third side surface.

The first resistor may include a first input electrode disposed on the first side surface, a first output electrode disposed on the second side surface, and a first resistor unit disposed on the front surface to connect the first input electrode and the first output electrode, and the second resistor may include a second input electrode disposed on the third side surface, a second output electrode disposed on the fourth side surface, and a second resistor unit disposed on the rear surface to connect the second input electrode and the second output electrode.

The body may be a single substrate formed of aluminum oxide (Al₂O₃).

The first resistor unit and the second resistor may be disposed to be perpendicular to each other.

Each of the first and second resistor units may include a notch to adjust the resistance value of each of the first and second resistor units.

The first resistor may further include a glass layer covering the first resistor unit, and the second resistor may further include a glass layer covering the second resistor unit.

Features and/or utilities of the present general inventive concept may also be realized by a method of fabricating an array resistor, the method including preparing a body having a front surface, a rear surface opposite to the front surface, and side surfaces connecting the front surface and the rear surface, forming a first resistor on the front surface, the first side surface, and the second side surface opposite to the first side surface, and forming a second resistor on the rear surface, the third side surface, and the fourth side surface opposite to the third side surface.

The method may further include, before the forming of the second resistor, rotating the body by 90° on a virtual axis penetrating the center of the body vertically and turning over the body.

The first electrode structure and the second electrode structure may be formed simultaneously, and the first resistor unit and the second resistor unit may be formed simultaneously.

The method may further include trimming the first resistor unit and the second resistor by a laser beam to adjust the resistance values of the first resistor unit and the second resistor unit.

Features and/or utilities of the present general inventive concept may also be realized by an array resistor including a body having a front surface, a rear surface opposite the front surface, and side surfaces connecting the front and rear surfaces, a first resistor extending across the front surface and onto two side surfaces adjacent to the front surface and opposite each other, and a second resistor extending across a first surface of the front surface, the rear surface, or one of the side surfaces and onto two surfaces adjacent to the first surface and opposite each other.

The first surface may be the front surface and the second resistor may extend onto two side surfaces adjacent to the front surface and opposite each other.

The first surface may be the rear surface and the second resistor may extend onto two side surfaces adjacent to the rear surface and opposite each other.

The first surface may be one of the side surfaces and the second resistor may extend onto the front surface and the rear surface. The first resistor may include a first resistive portion connected between first and second electrodes, the second resistor may include a second resistive portion connected between third and fourth electrodes, the first resistive portion of the first resistor may be located on the front surface, the first and second electrodes may be respectively located on the two sides adjacent to the front surface and opposite each other, the second resistive portion of the second resistor may be located on the first surface, and the third and fourth electrodes may be respectively located on the two sides adjacent to the first surface and opposite each other.

At least one of the first and second resistive portions may include a notch.

The array resistor may further include a first passivation layer on the first resistive portion and a second passivation layer on the second resistive portion.

At least one of the first and second resistive portions may include a notch, and the at least one corresponding first and second passivation layer also may include a notch corresponding to the notch of the at least one of the first and second resistive portions.

The array resistor may further include a third passivation layer located on the first passivation layer, and a fourth passivation layer located on the second passivation layer. The third and fourth passivation layers may not include a notch.

At least one of the first and second resistors may include at least two resistors positioned adjacent to each other on a same surface and extending onto same surfaces.

Features and/or utilities of the present general inventive concept may also be realized by a passive electrical component array, including a body having a front surface, a rear surface opposite the front surface, and side surfaces connecting the front and rear surfaces, a first passive electrical component extending across the front surface and onto two side surfaces adjacent to the front surface and opposite each other, and a second passive electrical component extending across a first surface being one of the front surface, the rear surface, or one of the side surfaces and onto two surfaces adjacent to the first surface and opposite each other.

At least one of the first and second passive electrical components may be a resistor, a capacitor, an inductor, or a diode.

The first passive electrical component may include a first passive electrical portion connected between first and second electrodes, the second passive electrical component may include a second passive electrical portion connected between third and fourth electrodes, the first passive electrical portion of the first resistor may be located on the front surface, the first and second electrodes may be respectively located on the two sides adjacent to the front surface and opposite each other, the second passive electrical portion of the second resistor may be located on the first surface, and the third and fourth electrodes may be respectively located on the two sides adjacent to the first surface and opposite each other.

At least one of the first and second passive electrical portions may include a notch. The passive electrical component array may further include a first passivation layer on the first passive electrical portion and a second passivation layer on the second passive electrical portion.

At least one of the first and second passive electrical portions may include a notch, and the at least one corresponding first and second passivation layer also may include a notch corresponding to the notch of the at least one of the first and second passive electrical portions. The passive electrical component array may further include a third passivation layer located on the first passivation layer and a fourth passivation layer located on the second passivation layer. The third and fourth passivation layers may not include a notch.

At least one of the first and second passive electrical components may include at least two passive electrical components positioned adjacent to each other on a same surface and extending onto same surfaces.

Features and/or utilities of the present general inventive concept may also be realized by a method of forming an array resistor, the method including forming a body having a front surface, a rear surface opposite the front surface, and side surfaces connecting the front and rear surfaces, forming a first resistor to extend across the front surface and onto two side surfaces adjacent to the front surface and opposite each other, and forming a second resistor to extend across a first surface of the front surface, the rear surface, or one of the side surfaces and onto two surfaces adjacent to the first surface and opposite each other.

Forming the first resistor may include forming a first resistive portion on the front surface and forming first and second electrodes on the side two sides adjacent to the front surface and opposite each other, the first and second electrodes formed to connect to the first resistive portion.

Forming the second resistor may include forming a second resistive portion on the first surface and forming third and fourth electrodes on the two sides adjacent to the first surface and opposite each other, the third and fourth electrodes formed to connect to the second resistive portion.

The method may further include forming a notch in at least one of the first and second resistive portions to adjust a resistance of the resistive portion.

The method may further include forming a first passivation layer on the first resistive portion and a second passivation layer on the second resistive portion.

The method may further include forming a notch in at least one of the first and second resistive portions to adjust a resistance of the resistive portion and forming a notch in at least one of the first and second passivation layer corresponding to the notch of the at least one of the first and second resistive portions.

The method may further include forming a third passivation layer on the first passivation layer, and forming a fourth passivation layer on the second passivation layer. The third and fourth passivation layers may not include a notch.

Forming at least one of the first and second resistors may include forming at least two resistors positioned adjacent to each other on a same surface and extending onto same surfaces.

Features and/or utilities of the present general inventive concept may also be realized by an electronic device including a circuit board, a semiconductor integrated circuit mounted on the circuit board, and at least one array resistor mounted on the circuit board and electrically connected to the semiconductor integrated circuit.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a perspective view of an array resistor according to an embodiment of the present general inventive concept;

FIG. 2 is a sectional view of the array resistor taken along a line I-I′ of FIG. 1;

FIG. 3 is a sectional view of the array resistor taken along a line II-II′ of FIG. 1;

FIG. 4A is a plan view of an array resistor according to an embodiment of the present general inventive concept;

FIG. 4B is a plan view of an array resistor of comparatively describing the integration density of the array resistor shown in FIG. 4A;

FIG. 5 is a flow chart illustrating an array resistor fabrication method according to an embodiment of the present general inventive concept;

FIGS. 6A to 6F are perspective views showing an array resistor fabrication process according to an embodiment of the present general inventive concept;

FIG. 7 is a flow chart illustrating another method of fabricating an array resistor according to an embodiment of the present general inventive concept;

FIGS. 8A to 8D are perspective views showing another method of fabricating an array resistor according to another embodiment of the present general inventive concept;

FIG. 9 is a perspective view of an array resistor according to another embodiment of the present general inventive concept;

FIG. 10 is a sectional view of the array resistor taken along a line III-III′ of FIG. 9;

FIG. 11 is a sectional view of the array resistor taken along a line IV-IV′ of FIG. 9;

FIG. 12A is a plan view of an array resistor according to another embodiment of the present general inventive concept;

FIG. 12B is a plan view of an array resistor for comparatively describing the integration density of the array resistor shown in FIG. 12A;

FIG. 13 is a perspective view of an array resistor according to still another embodiment of the present general inventive concept;

FIG. 14 is a sectional view of the array resistor taken along a line V-V′ of FIG. 13;

FIG. 15 is a sectional view of the array resistor taken along a line VI-VI′ of FIG. 13;

FIG. 16A is a plan view of an array resistor according to still another embodiment of the present general inventive concept;

FIG. 16B is a plan view of an array resistor for comparatively describing the integration density of the array resistor shown in FIG. 16A;

FIG. 17 is a diagram illustrating an electronic device according to an embodiment of the present general inventive concept

FIG. 18 illustrates a sectional view of an array resistor according to an embodiment of the present general inventive concept; and

FIG. 19 illustrates a sectional view of an array resistor according to an embodiment of the present general inventive concept.

### DETAILED DESCRIPTION OF THE EMBODIMENTS

Embodiments of the present general inventive concept will be described below in more detail with reference to the accompanying drawings. The present general inventive concept may, however, be embodied in different forms and should not be constructed as limited to the embodiments set forth herein. Rather, these embodiments are provided so that this disclosure will be thorough and complete, and will fully convey the scope of the present general inventive concept to those skilled in the art. Like reference numerals refer to like elements throughout the specification.

In the following description, the technical terms are used only for explaining specific exemplary embodiments while not limiting the present general inventive concept. The terms of a singular form may include plural forms unless otherwise specified. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, the embodiments in the detailed description will be described with reference to sectional views or plan views as ideal exemplary views of the present general inventive concept. In the drawings, the dimensions of layers and regions are exaggerated for clarity of illustration. Accordingly, shapes of the exemplary views may be modified according to manufacturing techniques and/or allowable errors. Therefore, the embodiments of the present general inventive concept are not limited to the specific shape illustrated in the exemplary views, but may include other shapes that may be created according to manufacturing processes. For example, although an etched region is illustrated as being angled, it may also be rounded. Areas exemplified in the drawings have general properties, and are used to illustrate specific shapes of device regions. Thus, these should not be construed as limiting the scope of the present general inventive concept.

Hereinafter, a detailed description will be given of an array resistor according to an embodiment of the present general inventive concept.

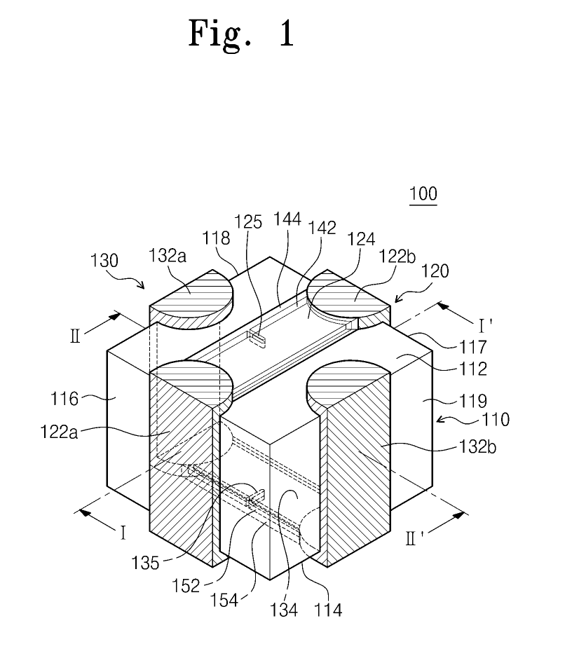

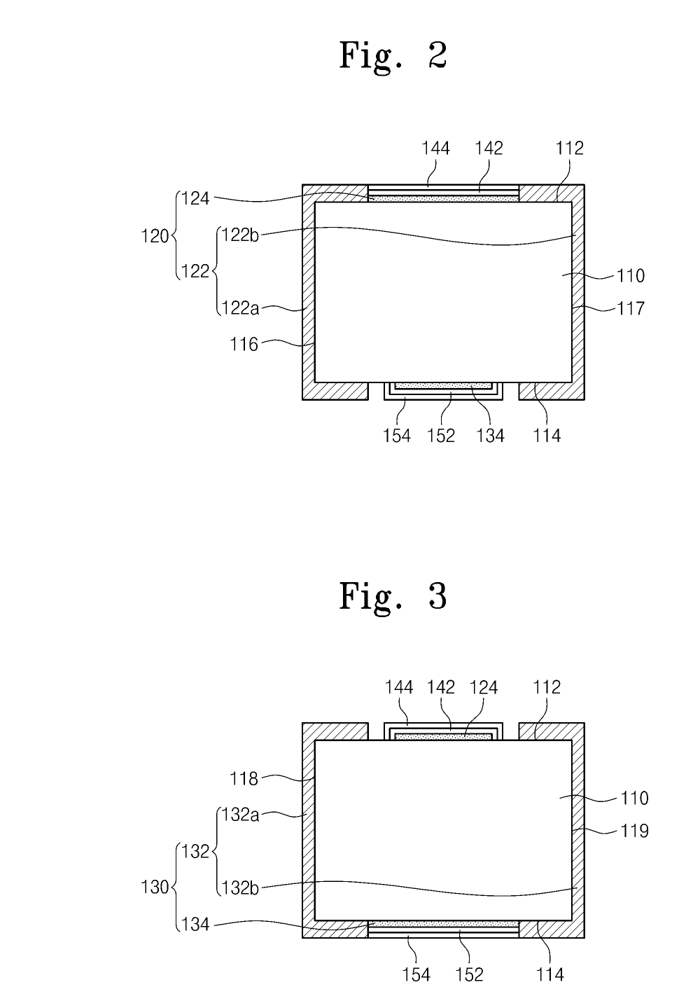

FIG. 1 is a perspective view of an array resistor according to an embodiment of the present general inventive concept. FIG. 2 is a sectional view of the array resistor taken along a line I-I′ of FIG. 1. FIG. 3 is a sectional view of the array resistor taken along a line II-II′ of FIG. 1.

Referring to FIGS. 1 to 3, an array resistor 100 according to an embodiment of the present general inventive concept may include a plurality of resistors disposed on one body. For example, the array resistor 100 may include a body 110, and first and second resistors 120 and 130 disposed on the body 110.

The body 110 may be a base for supporting the first and second resistors 120 and 130. For example, the body 110 may be a single substrate with a hexahedron shape. Accordingly, the body 110 may include a front surface 112, a rear surface 114 opposite to the front surface 112, and four side surfaces connecting the front surface 112 and the rear surface 114, which are hereinafter referred to as first to fourth side surfaces 116, 117, 118 and 119. The first side surface 116 and the second side surface 117 may be opposite to each other, and the third side surface 118 and the fourth side surface 119 may be opposite to each other. The front surface 112 and the rear surface 114 may have an approximately square shape, and the thickness of the body 110 may be smaller than the length of any one side of the front surface 112 and the rear surface 114. Accordingly, the body 110 may have an approximately rectangular hexahedron shape. Meanwhile, the body 110 may be formed of dielectric material. For example, the body 110 may be formed of aluminum oxide (Al₂O₃).

The first resistor 120 may include a first electrode structure 122 and a first resistor unit 124. The first electrode structure 122 may be disposed on the first side surface 116 and the second side surface 117. For example, the first electrode structure 122 may include a first input electrode 122a disposed on the first side surface 116 and a first output electrode 122b disposed on the second side surface 117. The first resistor unit 124 may be disposed in one direction on the front surface 112. The first resistor unit 124 may have a linear shape to connect the first input electrode 122a and the first output electrode 122b.

The second resistor 130 may include a second electrode structure 132 and a second resistor unit 134. The second electrode structure 132 may be disposed on the third side surface 118 and the fourth side surface 119. For example, the second electrode structure 132 may include a second input electrode 132a disposed on the third side surface 118 and a second output electrode 132b disposed on the fourth side surface 119. The second resistor unit 134 may be disposed on the rear surface 114. The second resistor unit 134 may have a linear shape to connect the second input electrode 132a and the second output electrode 132b. Accordingly, the second resistor unit 134 may be disposed in a direction approximately perpendicular to the lengthwise direction of the first resistor unit 124.

Meanwhile, the first resistor unit 124 may have a first notch, cut, or slit 125, and the second resistor unit 134 may have a second notch 135. The first notch 125 and the second notch 135 may serve to control the resistance values of the first resistor 120 and the second resistor 130, respectively. The first and second notches 125 and 135 will be described later in detail.

The array resistor 100 may further include a first resistor unit passivation layer 144 covering the first resistor unit 124, and a second resistor unit passivation layer 154 covering the second resistor unit 134. The first resistor unit passivation layer 144 and the second resistor unit passivation layer 154 may protect the first resistor unit 124 and the second resistor unit 134 from external environments, respectively. In addition, a first passivation layer 142 may be disposed between the first resistor unit 124 and the first resistor unit passivation layer 144, and a second passivation layer 152 may be disposed between the second resistor unit 134 and the second resistor unit passivation layer 154. The first passivation layer 142 may serve to protect the first resistor unit 124 when forming the first notch 125 at the first resistor unit 124. The second passivation layer 152 may serve to protect the second resistor unit 134 when forming the second notch 135 at the second resistor unit 134. Meanwhile, the first resistor unit passivation layer 144 and the second resistor unit passivation layer 154 may be formed of silica-based material such as glass. Also, the first passivation layer 142 and the second passivation layer 152 may be formed of silica-based material. Accordingly, the first resistor unit 124 and the second resistor unit 134 may be covered and protected by a double layer formed of silica-based material.

The array resistor 100 may have a structure that uses all the surfaces (112, 114 and 116 to 119) of the body 110 to dispose the first and second resistors 120 and 130. In this case, the first and second resistor units 124 and 134 may be respectively disposed in a crossing direction on the front surface 112 and the rear surface 114 of the body 110, thereby preventing an electrical short between the first and second resistors 120 and 130. Also, the interval between the first and second resistors 120 and 130 may be adjusted to the minimum length to prevent an electrical short between the first and second resistors 120 and 130. Accordingly, the integration density of the array resistor 110 can be improved.

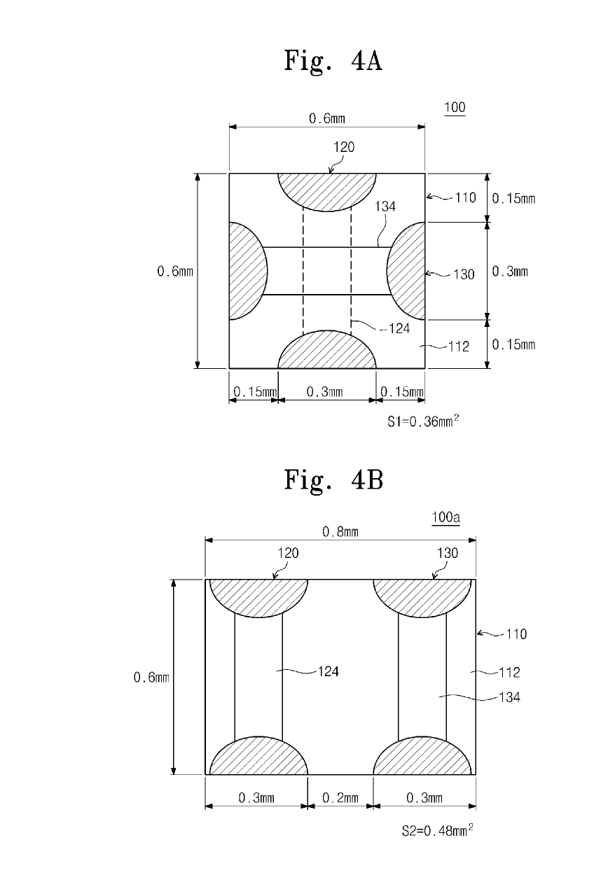

A description will be given of the integration density of the array resistor 100 according to the arrangement of the first and second resistors 120 and 130. FIG. 4A is a plan view of an array resistor according to an embodiment of the present general inventive concept. FIG. 4B is a plan view of an array resistor for comparatively describing the integration density of the array resistor shown in FIG. 4A.

Referring to FIG. 4A, an array resistor 100 according to an embodiment of the present general inventive concept may have a structure that uses all the surfaces of a body 110 to dispose first and second resistors 120 and 130. In this case, a first resistor unit 124 and a second resistor unit 134 may be disposed respectively on the opposite surfaces of the body 110. Thus, only the first resistor unit 124 may be disposed in one direction on a front surface 112 of the body 110. If the first and second resistors 120 and 130 have a width of about 0.3 mm, one side of the body 110 may be adjusted to have a length of about 0.6 mm. Thus, the front surface 112 or a rear surface 114 may have an area S1 of about 0.36 mm² (0.6 mm×0.6 mm).

Referring to FIG. 4B, an array resistor 100a may have a structure that uses only one surface (i.e., a front surface 112) of a hexahedron body 110 to dispose first and second resistors 120 and 130. In this case, first and second resistor units 124 and 134 may be disposed in one direction on the front surface 112 of the body 110. If the first and second resistors 120 and 130 have a width of about 0.3 mm, one side of the body 110 may have a length of about 0.6 mm and another side of the body 110 may have a length of about 0.8 mm. Thus, the front surface 112 may have an area S2 of about 0.48 mm² (0.6 mm×0.8 mm).

As described with reference to FIGS. 4A and 4B, the array resistor 100 that uses all the surfaces of the body 110 to dispose the first and second resistors 120 and 130, can have a smaller size than the array resistor 100a that uses only some surfaces of the body 110 to dispose the first and second resistors 120 and 130. Accordingly, the array resistor 100 according to the embodiment of the present general inventive concept can have a higher integration density than the array resistor 100a of FIG. 4B.

Hereinafter, a detailed description will be given of an array resistor fabrication method according to an embodiment of the present general inventive concept. Herein, a detailed description of an overlap with the above description of the array resistor 100 according to the embodiment of the present general inventive concept will be omitted for conciseness.

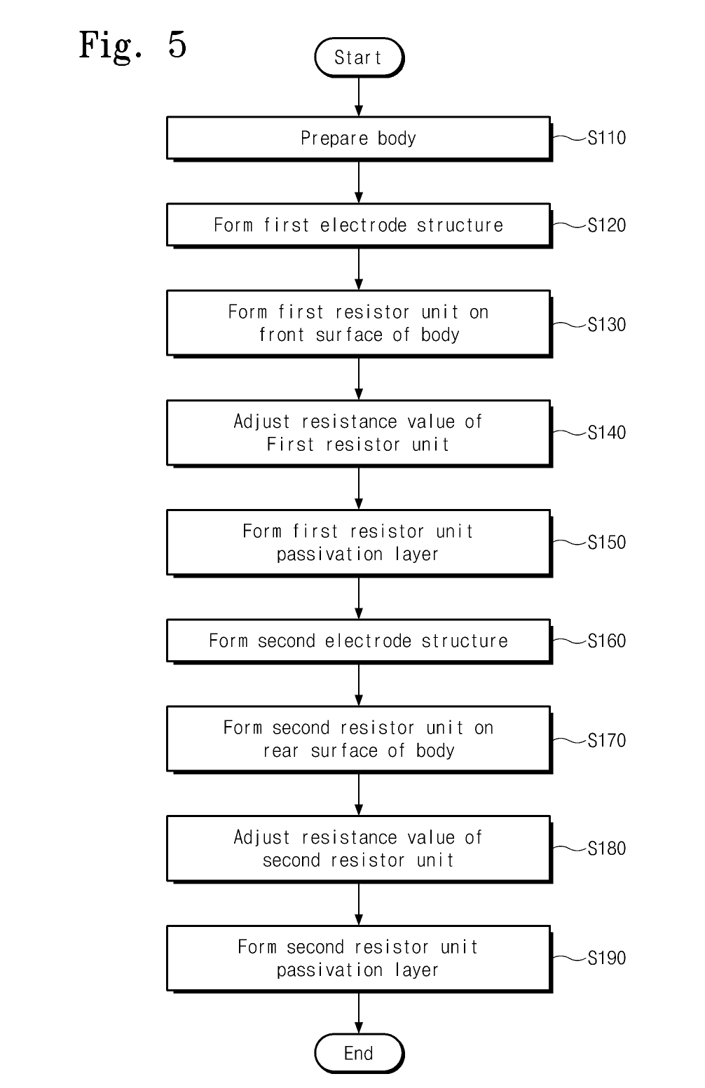

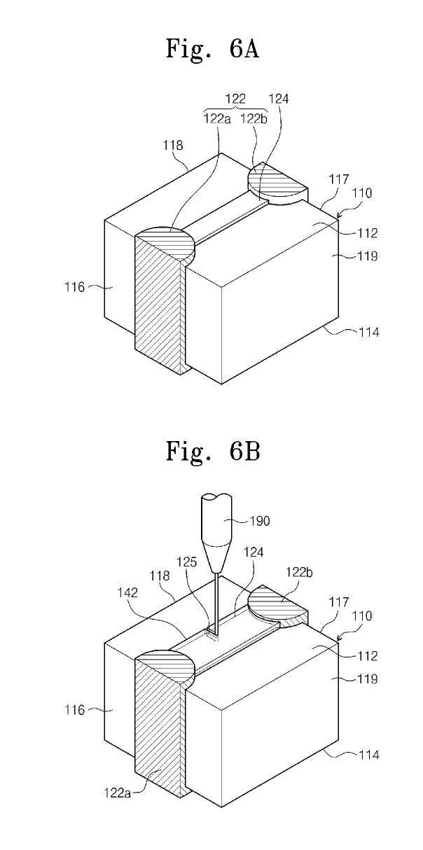

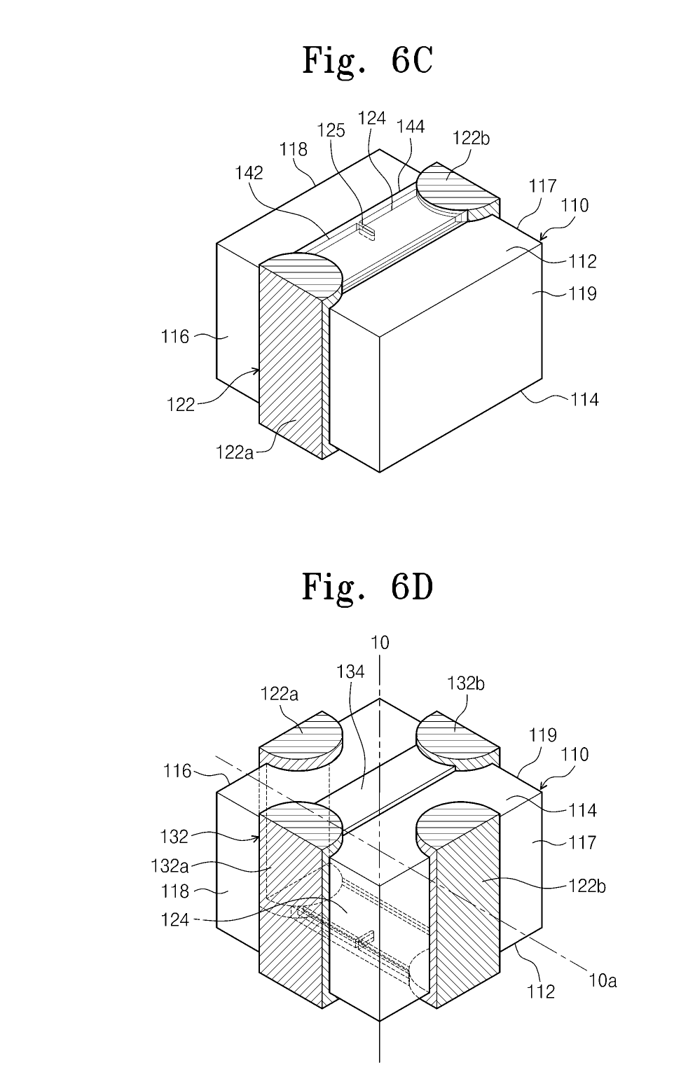

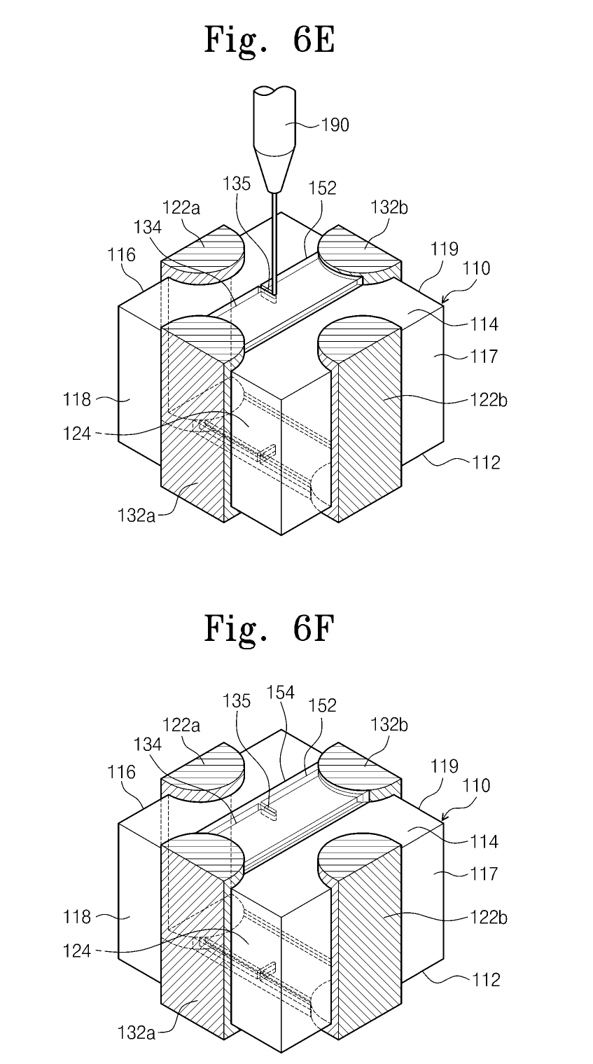

FIG. 5 is a flow chart illustrating an array resistor fabrication method according to an embodiment of the present general inventive concept. FIGS. 6A to 6F are perspective views showing an array resistor fabrication process according to an embodiment of the present general inventive concept.

Referring to FIGS. 5 and 6A, a body 110 is prepared (S110). The preparing of the body 110 may include preparing a dielectric substrate with an approximately hexahedron shape. For example, the preparing of the body 110 may include preparing a dielectric substrate that has a front surface 112, a rear surface 114 opposite to the front surface 112, and first to fourth side surfaces 116 to 119 connecting the front surface 112 and the rear surface 114. The first and second side surfaces 116 and 117 may be opposite to each other, and the third and fourth side surfaces 118 and 119 may be opposite to each other. The dielectric substrate may be formed of aluminum oxide (Al₂O₃). Meanwhile, the preparing of the body 110 may further include arranging the body 110 to direct the front surface 112 to face a predetermined direction, such as upward.

A first electrode structure 122 is formed on the body 110 (S120). For example, the forming of the first electrode structure 122 may include forming a first input electrode 122a on the first side surface 116 and forming a first output electrode 122b on the second side surface 117. The forming of the first input electrode 122a and the forming of the first output electrode 122b may include forming a metal line on the first and second side surfaces 116 and 117, respectively.

A first resistor unit 124 is formed on the front surface 112 of the body 110 (S130). The forming of the first resistor unit 124 may include forming a resistor line on the front surface 112 to connect the first input electrode 122a and the first output electrode 122b. The resistor line may be formed of ruthenium oxide (RuO₂). Accordingly, the first resistor unit 124 is formed in one direction on the front surface 112.

Referring to FIGS. 5 and 6B, the resistance value of the first resistor unit 124 is adjusted (S140). The adjusting of the resistance value of the first resistor unit 124 may include trimming the first resistor unit 124. For example, the trimming of the first resistor unit 124 may be performed using a laser irradiator 190. The laser irradiator 190 irradiates a laser beam onto the first resistor unit 124 to cut a portion of the first resistor unit 124 in a direction approximately perpendicular to the lengthwise direction of the first resistor unit 124. Accordingly, a first notch 125 is formed at the first resistor unit 124. The length of the first notch 125 is controlled to adjust the resistance value of the first resistor unit 124 to a predetermined resistance value.

After the forming of the first resistor unit 124, a first passivation layer 142 may be formed to cover the first resistor unit 124. The first passivation layer 142 serves to prevent a damage to the first resistor unit 124 when adjusting the resistance value of the first resistor unit 124. Accordingly, the forming of the first passivation layer 142 may be performed before the forming of the first notch 125. The forming of the first passivation layer 142 may include forming a dielectric layer covering the first resistor unit 124. For example, the forming of the dielectric layer may include covering the first resistor unit 124 with a layer of silica-based material such as glass.

Referring to FIGS. 5 and 6C, a first resistor unit passivation layer 144 is formed (S150). The first resistor unit passivation layer 144 serves to protect the first resistor unit 124 from external environments. The forming of the first resistor unit passivation layer 144 may include forming a dielectric layer covering the first resistor unit 124. For example, the forming of the first resistor unit passivation layer 144 may include covering the first resistor unit 124 with a layer of silica-based material such as glass. If the forming of the first passivation layer 142 is performed as described with reference to FIG. 6B, the first resistor unit 124 is covered with the first passivation layer 142 and the first resistor unit passivation layer 144 so that it can be protected from the external environments.

Referring to FIGS. 5 and 6D, a second electrode structure 132 is formed at the body 110 (S160). The forming of the second electrode structure 132 may include forming a second input electrode 132a on the third side surface 118 and forming a second output electrode 132b on the fourth side surface 119. The forming of the second input electrode 132a and the forming of the second output electrode 132b may include forming a metal line on the third and fourth side surfaces 118 and 119, respectively.

A second resistor unit 134 is formed on the rear surface 114 of the body 110 (S170). The forming of the second resistor unit 134 may include forming a resistor line on the rear surface 114 to connect the second input electrode 132a and the second output electrode 132b. The resistor line may be formed of ruthenium oxide (RuO₂). Accordingly, the second resistor unit 134 is formed on the rear surface 114 in a direction approximately perpendicular to the first resistor unit 124.

Meanwhile, the body 110 may be rotated or turned over before the forming of the second electrode structure 132 and the second resistor unit 134. The rotating and turning over of the body 110 serves to align the body 110 with an equipment for forming the second electrode structure 132 and the second resistor unit 134. For example, before the forming of the second electrode structure 132 and the second resistor unit 134, the rotating and turning over of the body 110 may include rotating the body 110 by 90° on a virtual axis penetrating the center of the body 110 vertically, and turning over the body 110. In other words, the body 110 may be rotated 180° about a virtual axis 10a that horizontally passes through a center of the body 110 and also rotated 90° about the vertical axis 10. Accordingly, the location of the first and second side surfaces 116 and 117 and the location of the third and fourth side surfaces 118 and 119 are interchanged. In addition, the body 110 is arranged to direct the front surface 112 downward and the rear surface 114 upward.

Referring to FIGS. 5 and 6E, the resistance value of the second resistor unit 134 may be adjusted (S180). The adjusting of the resistance value of the second resistor unit 134 may be performed in substantially the same way as the adjusting of the resistance value of the first resistor unit 124, which has been described with reference to FIG. 6B. The controlling of the resistance value of the second resistor unit 134 may include trimming the second resistor unit 134 by using a laser irradiator 190. Accordingly, a second notch 135 is formed at the first resistor unit 124. The length of the second notch 135 is controlled to adjust the resistance value of the second resistor unit 134 to a predetermined resistance value.

After the forming of the second resistor unit 134, a second passivation layer 152 may be formed to cover the second resistor unit 134. The second passivation layer 152 serves to prevent damage to the second resistor unit 134 when adjusting the resistance value of the second resistor unit 134. Accordingly, the forming of the second passivation layer 152 may be performed before the forming of the second notch 135. The forming of the second passivation layer 152 may be performed in substantially the same way as the forming of the first passivation layer 142, which has been described with reference to FIG. 6B. For example, the forming of the second passivation layer 152 may include covering the second resistor unit 134 with a glass layer.

Referring to FIGS. 5 and 6F, a second resistor unit passivation layer 144 may be formed (S190). The second resistor unit passivation layer 154 serves to protect the second resistor unit 134 from external environments. The forming of the second resistor unit passivation layer 154 may be performed in substantially the same way as the forming of the forming of the first resistor unit passivation layer 144, which has been described with reference to FIG. 6C. For example, the forming of the second resistor unit passivation layer 154 may include covering the second resistor unit 134 with a glass layer. When the forming of the second passivation layer 152 is performed as described with reference to FIG. 6B, the second resistor unit 134 is covered and protected by a double glass layer.

Hereinafter, a detailed description will be given of an array resistor fabrication method according to another embodiment of the present general inventive concept. Herein, a detailed description of an overlap with the above description of the array resistor fabrication method according to the embodiment of the present general inventive concept will be omitted for conciseness.

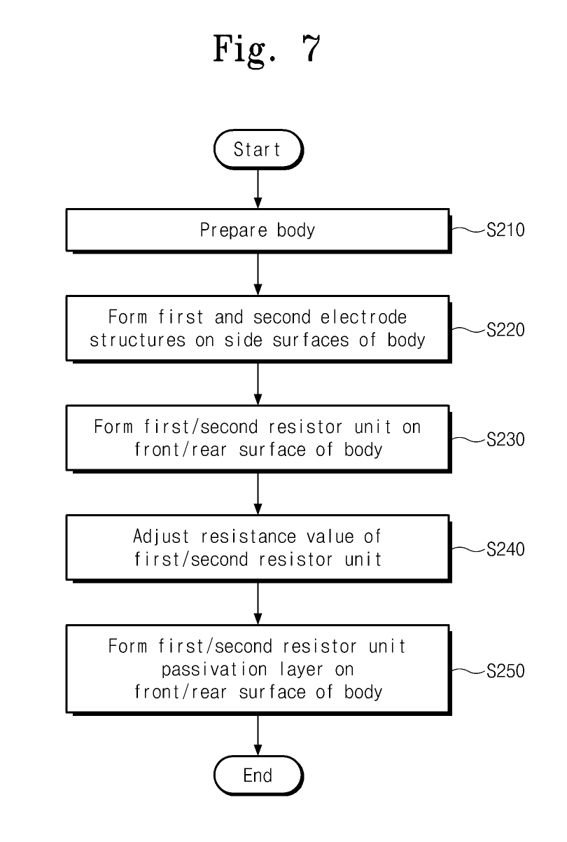

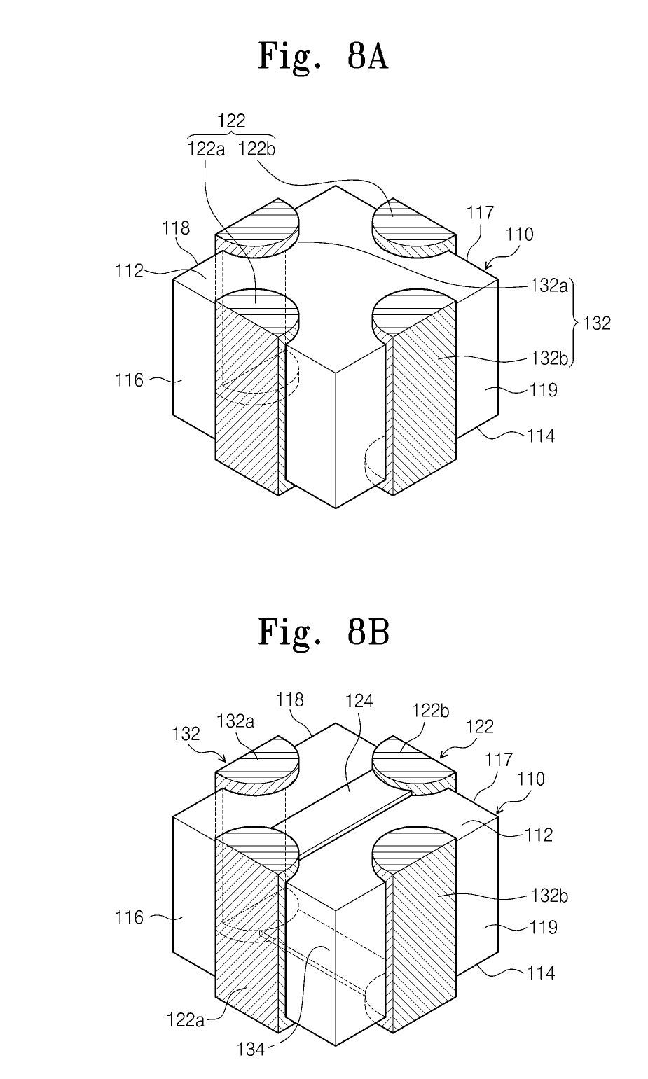

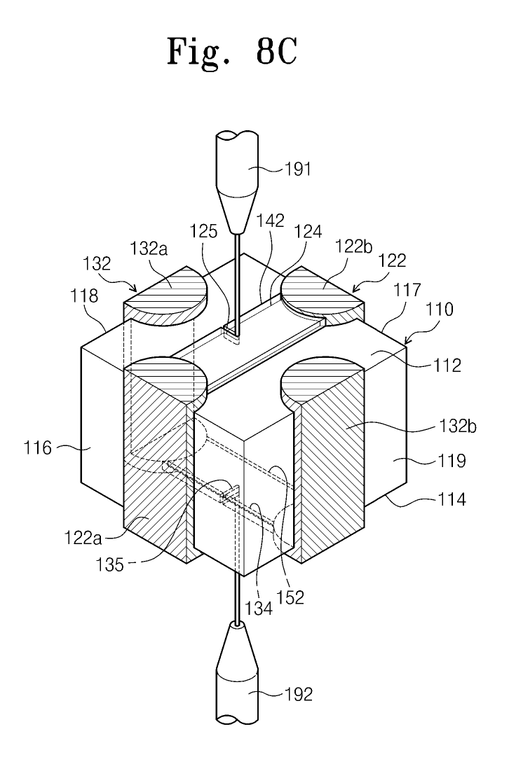

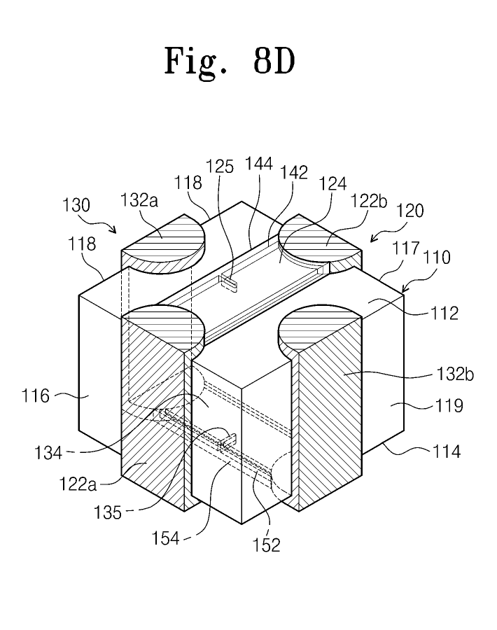

FIG. 7 is a flow chart illustrating another method of fabricating an array resistor according to an embodiment of the present general inventive concept. FIGS. 8A to 8D are perspective views showing another method of fabricating an array resistor according to an embodiment of the present general inventive concept.

Referring to FIGS. 7 and 8A, a body 110 is prepared (S210). The preparing of the body 110 may include preparing an aluminum oxide (Al₂O₃) dielectric substrate that has a front surface 112, a rear surface 114 opposite to the front surface 112, and first to fourth side surfaces 116 to 119 connecting the front surface 112 and the rear surface 114.

A first electrode structure 122 and a second electrode structure 132 are formed on the first to fourth side surfaces 116 to 119 of the body 110 (S220). For example, the forming of the first electrode structure 122 may include forming a first input electrode 122a on the first side surface 116 and forming a first output electrode 122b on the second side surface 117. The forming of the second electrode structure 132 may include forming a second input electrode 132a on the third side surface 118 and forming a second output electrode 132b on the fourth side surface 119. The forming of the first electrode structure 122 and the forming of the second electrode structure 132 may be performed simultaneously.

Referring to FIGS. 7 and 8B, a first resistor unit 124 and a second resistor unit 134 are formed respectively on the front surface 112 and the rear surface 114 of the body 110 (S230). The forming of the first resistor unit 124 may include forming a ruthenium oxide (RuO₂) resistor line on the front surface 112 to connect the first input electrode 122a and the first output electrode 122b. The forming of the second resistor unit 134 may include forming a ruthenium oxide (RuO₂) resistor line on the rear surface 114 to connect the second input electrode 132a and the second output electrode 132b. Accordingly, the first resistor unit 124 is formed on the front surface 112 in one direction, and the second resistor unit 134 is formed on the rear surface 114 in a direction perpendicular to the lengthwise direction of the first resistor unit 124. The forming of the first resistor unit 124 and the forming of the second resistor unit 134 may be performed simultaneously.

Referring to FIGS. 7 and 8C, the resistance value of the first/second resistor unit 124/134 is adjusted (S240). The adjusting of the resistance value of the first/second resistor unit 124/134 may include trimming the first/second resistor unit 124/134 by using a first/second laser irradiator 191/192. The adjusting of the resistance value of the first/second resistor unit 124/134 may be performed simultaneously. Accordingly, a first/second notch 125/135 is formed at the first/second resistor unit 124/134.

A first/second passivation layer 142/152 may be formed to cover the first/second resistor unit 124/134. The forming of the first/second passivation layer 142/152 may be performed before the trimming of the first/second resistor unit 124/134. The forming of the first/second passivation layer 142/152 may include forming a glass layer covering the first/second resistor unit 124/125. The forming of the first/second passivation layer 142/152 may be performed simultaneously.

Referring to FIGS. 7 and 8D, a first/second resistor unit passivation layer 144/154 is formed on the front/rear surface 112/114 of the body 112 (S250). The forming of the first resistor unit passivation layer 144 may include forming a glass layer covering the first resistor unit 124, and the forming of the second resistor unit passivation layer 154 may include forming a glass layer covering the second resistor unit 134. When the forming of the first/second passivation layer 142/152 is performed as described above, the first/second resistor unit 124/134 is covered with a double glass layer so that they can be protected from the external environments.

In the array resistor fabrication method according to the embodiment of FIG. 7, the first and second electrode structures 122 and 132 are formed simultaneously, the first and second resistor units 124 and 134 are formed simultaneously, and the first and second resistor unit passivation layers 144 and 154 are formed simultaneously. Also, unlike the array resistor fabrication method according to the embodiment of FIG. 5, the array resistor fabrication method according to the embodiment of FIG. 7 can omit the rotating and turning over of the body 110. Accordingly, the array resistor fabrication method according to the embodiment of FIG. 7 can be simpler than the array resistor fabrication method according to the embodiment of FIG. 5.

Hereinafter, a detailed description will be given of an array resistor according to another embodiment of the present general inventive concept.

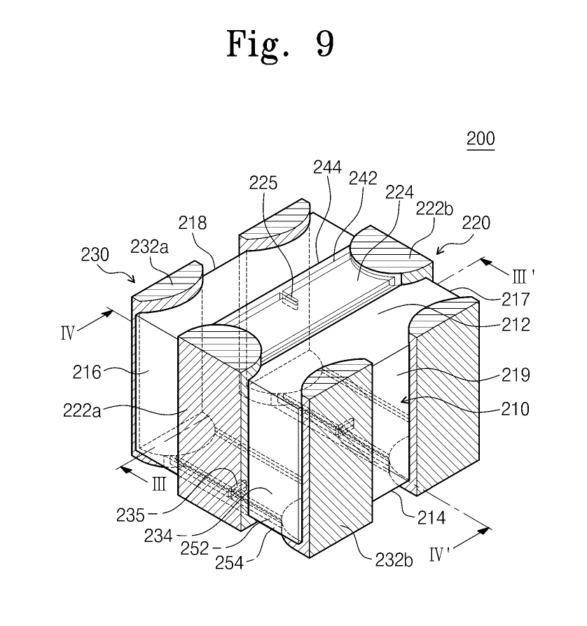

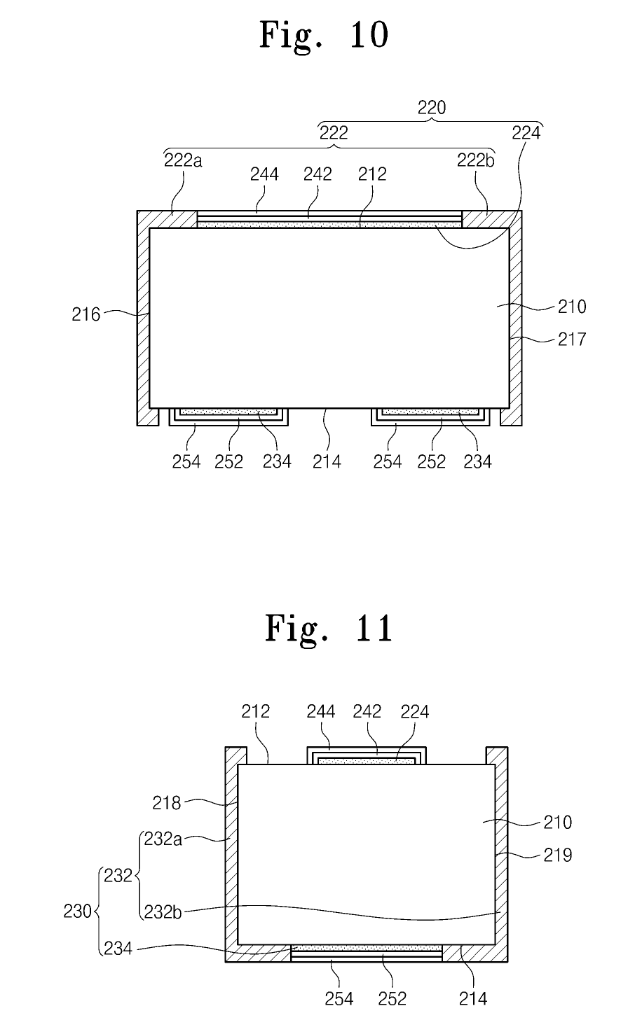

FIG. 9 is a perspective view of an array resistor according to another embodiment of the present general inventive concept. FIG. 10 is a sectional view of the array resistor taken along a line III-III′ of FIG. 9. FIG. 11 is a sectional view of the array resistor taken along a line IV-IV′ of FIG. 9.

Referring to FIGS. 9 to 11, an array resistor 200 according to another embodiment of the present general inventive concept may include a body 210 and different numbers of first resistors 220 and second resistors 230 disposed on the body 210. The present embodiment illustrates that the array resistor 200 has one first resistor 220 and two second resistors 230.

The body 210 may be a base for supporting the first and second resistors 220 and 230. For example, the body 210 may have an approximately hexahedron shape. The body 210 may include a front surface 212, a rear surface 214 opposite to the front surface 212, and four side surfaces connecting the front surface 212 and the rear surface 214, which are hereinafter referred to as first to fourth side surfaces 216, 217, 218 and 219. The first side surface 216 and the second side surface 217 may be opposite to each other, and the third side surface 218 and the fourth side surface 219 may be opposite to each other. The front surface 212 and the rear surface 214 may have a rectangular shape, and the thickness of the body 210 may be smaller than the length of any one side of the front surface 212 and the rear surface 214. Accordingly, the body 210 may have a rectangular hexahedron shape. The body 210 may be formed of dielectric material. For example, the body 210 may be formed of aluminum oxide (Al₂O₃).

The first resistor 220 may include a first electrode structure 222 and a first resistor unit 224. The first electrode structure 222 may include a first input electrode 222a disposed on the first side surface 216 and a first output electrode 222b disposed on the second side surface 217. The first resistor unit 224 may be a resistor line that is disposed on the front surface 212 to connect the first input electrode 222a and the first output electrode 222b. The first resistor unit 224 may have a first notch 225. The first notch 225 serves to adjust the resistance value of the first resistor unit 224.

Each of the second resistors 230 may include a second electrode structure 232 and a second resistor unit 234. The second electrode structure 232 may include a second input electrode 232a disposed on the third side surface 218 and a second output electrode 232b disposed on the fourth side surface 219. The second resistor unit 234 may be a resistor line that is disposed on the rear surface 214 to connect the second input electrode 232a and the second output electrode 232b. Accordingly, the second resistor unit 234 may be disposed on the rear surface 214 in a direction approximately perpendicular to the first resistor unit 224. The second resistor unit 234 may have a second notch 235. The second notch 235 serves to adjust the resistance value of the second resistor unit 234.

As described above, with respect to FIGS. 1-8D, the first resistor unit 224 and the second resistor units 234 may be coated with first and second passivation layers 242, 252, respectively. The first and second passivation layers 242, 252 may be applied to the resistor units 224, 234 before the notches 225, 235 are formed so that the first and second passivation layers may include notches corresponding to the notches 225, 235. First and second resistor unit passivation layers 244, 254 may be formed on the first and second passivation layers 242, 252, respectively.

As described above, the first resistor 220 is disposed to occupy the front surface 212, the first side surface 216, and the second side surface 217, and the second resistors 230 are disposed to occupy the rear surface 214, the third side surface 218, and the fourth side surface 218. The first resistor 220 and the second resistors 230 may be disposed at the minimum intervals to prevent an electrical short therebetween. Also, the pitch of the second resistors 230 may be adjusted to the minimum value to prevent an electrical short between the second resistors 230. Accordingly, the array resistor 200 can prevent an electrical short between the first and second resistors 220 and 230 and can have an improved integration density.

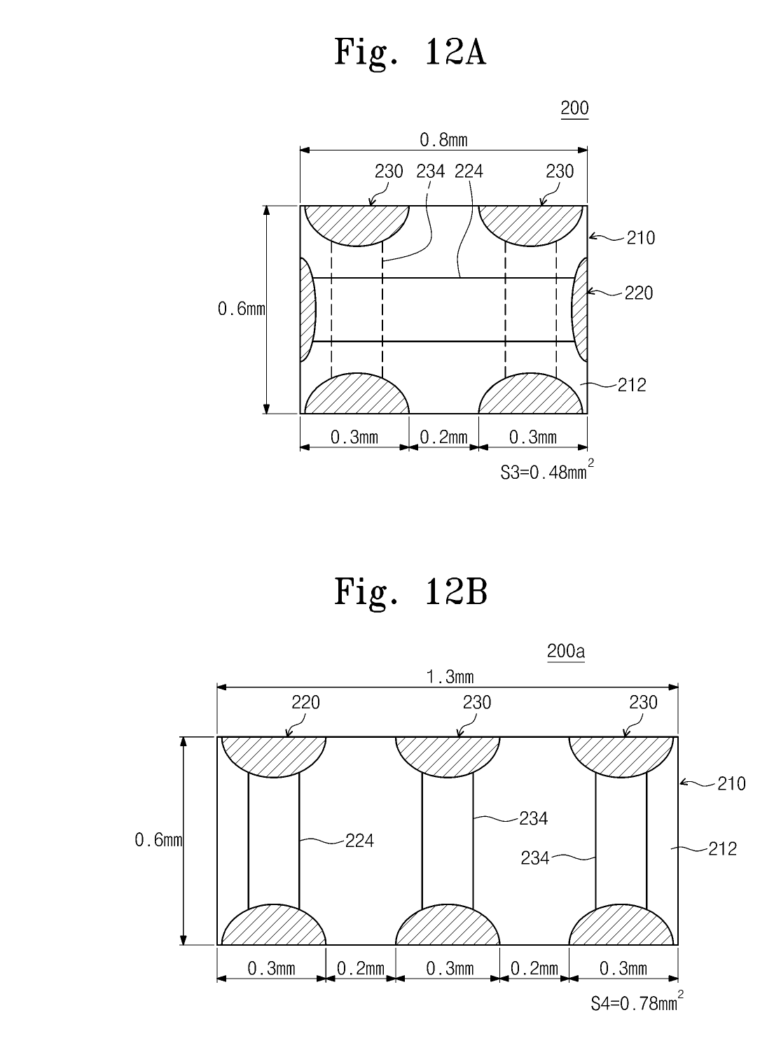

A description will be given of the integration density of the array resistor according to the arrangement of the above resistors. FIG. 12A is a plan view of an array resistor according to another embodiment of the present general inventive concept. FIG. 12B is a plan view of an array resistor for comparatively describing the integration density of the array resistor shown in FIG. 12A.

Referring to FIG. 12A, as described above, an array resistor 200 according to another embodiment of the present general inventive concept may have a structure that uses all the surfaces of a hexahedron body 210 to dispose first and second resistors 220 and 230. In this case, a first resistor unit 224 and a second resistor unit 234 may be disposed respectively on the opposite surfaces of the body 210. If the first and second resistors 220 and 230 have a width of about 0.3 mm, one side of the body 210 may have a length of about 0.6 mm and another side of the body 210 may be adjusted to have a length of about 0.8 mm. Thus, the front surface 212 may have an area S3 of about 0.48 mm² (0.6 mm×0.8 mm).

Referring to FIG. 12B, an array resistor 200a may have a structure that uses only a front surface 212 of a hexahedron body 210 to dispose first and second resistors 220 and 230. In this case, all of first and second resistor units 224 and 234 may be disposed on one surface (i.e., the front surface 212) of the body 210. If the first and second resistors 220 and 230 have a width of about 0.3 mm, one side of the body 210 may have a length of about 0.6 mm and another side of the body 210 may have a length of about 1.3 mm. Thus, the front surface 212 may have an area S4 of about 0.78 mm² (0.6 mm×1.3 mm).

As described with reference to FIGS. 12A and 12B, the array resistor 200 that uses all the surfaces of the body 210 to dispose the first and second resistors 220 and 230, can have a smaller size than the array resistor 200a that uses only some surfaces of the body 210 to dispose the first and second resistors 220 and 230. Accordingly, the array resistor 200 according to the embodiment of the present general inventive concept can have a higher integration density than the array resistor 200a of FIG. 12B.

Hereinafter, a detailed description will be given of an array resistor according to still another embodiment of the present general inventive concept.

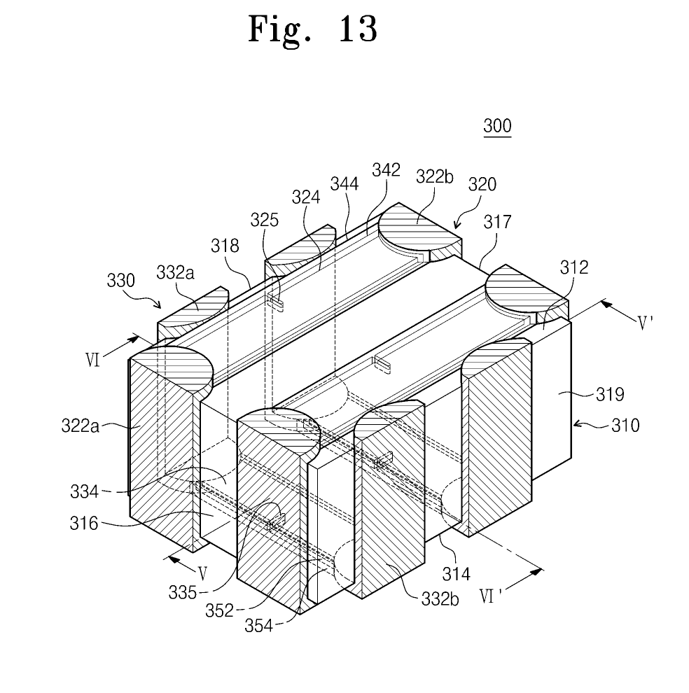

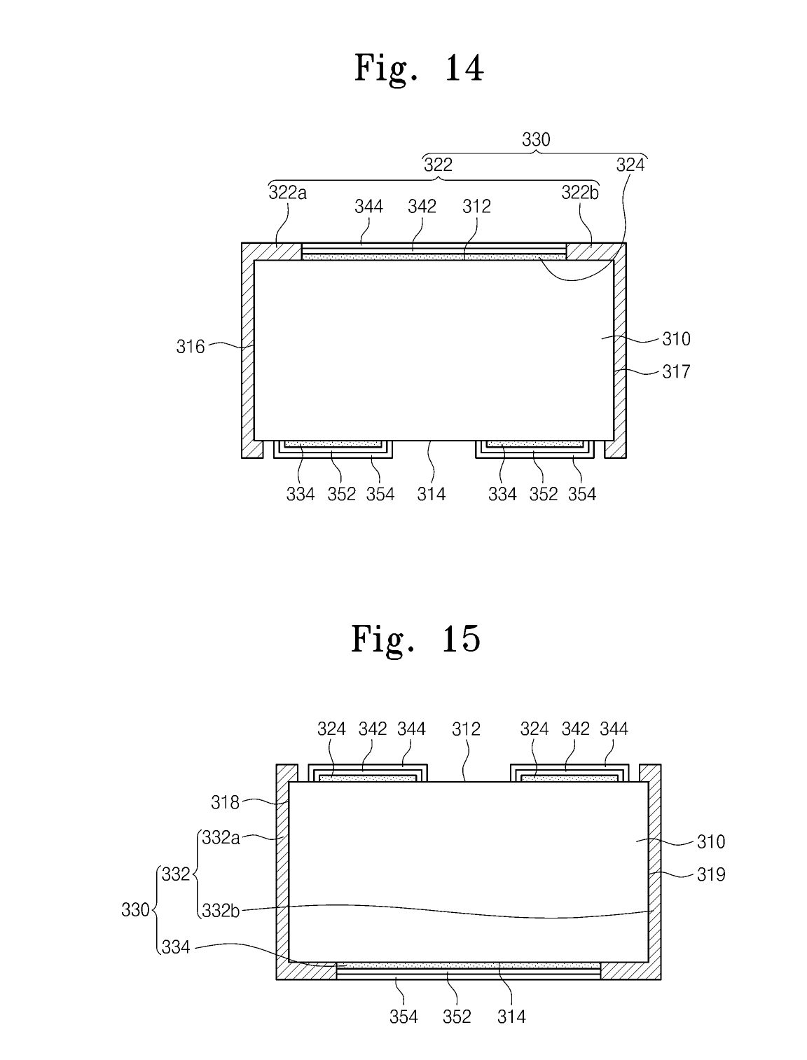

FIG. 13 is a perspective view of an array resistor according to still another embodiment of the present general inventive concept. FIG. 14 is a sectional view of the array resistor taken along a line V-V′ of FIG. 13. FIG. 15 is a sectional view of the array resistor taken along a line VI-VI′ of FIG. 13.

Referring to FIGS. 13 to 15, an array resistor 300 according to still another embodiment of the present general inventive concept may include a body 310 and a plurality of first resistors 320 and a plurality of second resistors 330 disposed on the body 310. The number of the first resistors 320 may be equal to the number of the second resistors 330. The present embodiment illustrates that the array resistor 300 has two first resistors 320 and two second resistors 330. However, the array resistor 300 may have three or more first resistors 320 and three or more second resistors 330.

The body 310 may be a base for supporting the first and second resistors 320 and 330. For example, the body 310 may have an approximately hexahedron shape. The body 310 may include a front surface 312, a rear surface 314 opposite to the front surface 312, and four side surfaces connecting the front surface 312 and the rear surface 314, which are hereinafter referred to as first to fourth side surfaces 316, 317, 318 and 319. The first side surface 316 and the second side surface 317 may be opposite to each other, and the third side surface 318 and the fourth side surface 319 may be opposite to each other. The front surface 312 and the rear surface 314 may have a rectangular shape, and the thickness of the body 310 may be smaller than the length of any one side of the front surface 312 and the rear surface 314. Accordingly, the body 310 may have a rectangular hexahedron shape. The body 310 may be formed of dielectric material. For example, the body 310 may be formed of aluminum oxide (Al₂O₃).

Each of the first resistors 320 may include a first electrode structure 322 and a first resistor unit 324. The first electrode structure 322 may be disposed on the first side surface 316 and the second side surface 317. For example, the first electrode structure 322 may include a first input electrode 322a disposed on the first side surface 316 and a first output electrode 322b disposed on the second side surface 317. The first resistor unit 324 may be a resistor line that is disposed on the front surface 312 to connect the first input electrode 322a and the first output electrode 322b.

Each of the second resistors 330 may include a second electrode structure 332 and a second resistor unit 334. The second electrode structure 332 may be disposed on the third side surface 318 and the fourth side surface 319. For example, the second electrode structure 332 may include a second input electrode 332a disposed on the third side surface 318 and a second output electrode 332b disposed on the fourth side surface 319. The second resistor unit 334 may be a resistor line that is disposed on the rear surface 314 to connect the second input electrode 332a and the second output electrode 332b. Accordingly, the second resistor unit 334 may be disposed on the rear surface 314 in a direction approximately perpendicular to the first resistor unit 324.

As described above, the first resistors 320 are disposed to occupy the front surface 312, the first side surface 316, and the second side surface 317, and the second resistors 330 are disposed to occupy the rear surface 314, the third side surface 318, and the fourth side surface 318. The first resistors 320 and the second resistors 330 may be disposed at the minimum intervals to prevent an electrical short therebetween. Also, the pitch of the first resistors 320 may be adjusted to the minimum value to prevent an electrical short between the first resistors 320. Likewise, the pitch of the second resistors 330 may be adjusted to the minimum value to prevent an electrical short between the second resistors 330. Accordingly, the array resistor 300 can prevent an electrical short between the first and second resistors 320 and 330 and can have an improved integration density.

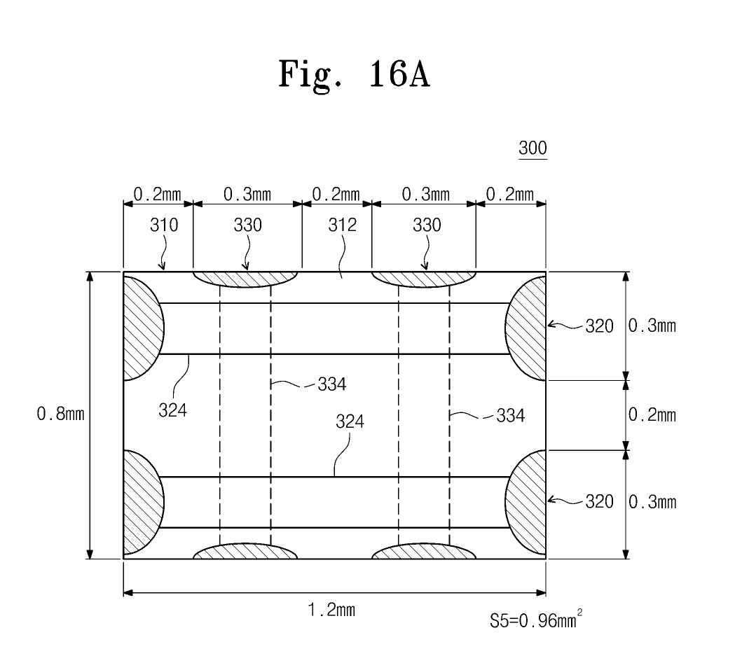

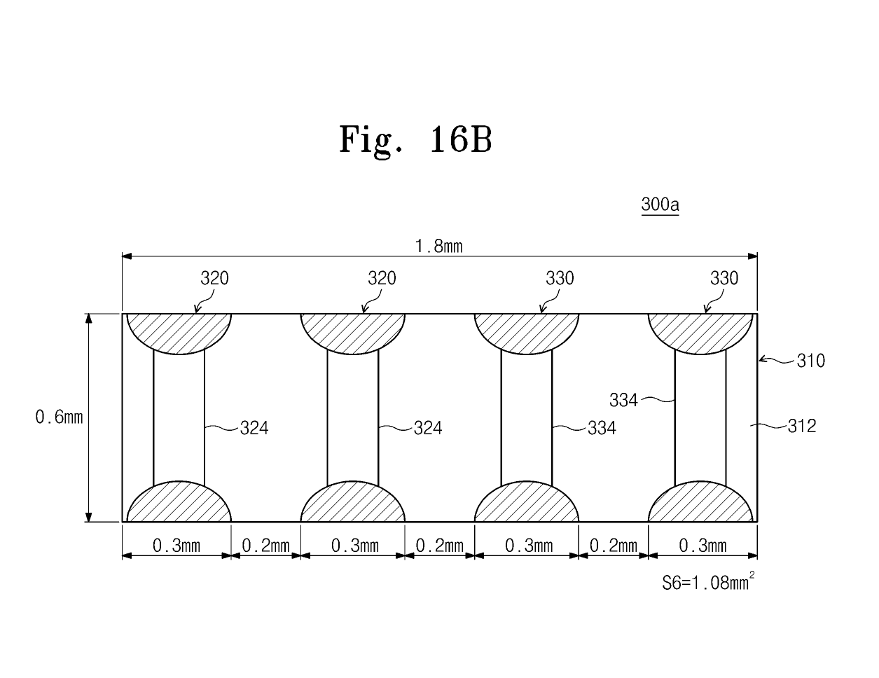

A description will be given of the integration density of the array resistor according to the arrangement of the above resistors. FIG. 16A is a plan view of an array resistor according to still another embodiment of the present general inventive concept. FIG. 16B is a plan view of an array resistor for comparatively describing the integration density of the array resistor shown in FIG. 16A.

Referring to FIG. 16A, as described above, an array resistor 300 according to still another embodiment of the present general inventive concept may have a structure that uses all the surfaces of a hexahedron body 310 to dispose first and second resistors 320 and 330. In this case, a plurality of first resistor units 324 and a plurality of second resistor units 334 may be disposed respectively on the opposite surfaces of the body 310. Thus, only the first resistor units 324 may be disposed on the front surface 312. If the first and second resistors 320 and 330 have a width of about 0.3 mm, one side of the body 310 may have a length of about 0.8 mm and another side of the body 310 may be adjusted to have a length of about 1.2 mm. Thus, the front surface 312 may have an area S5 of about 0.96 mm² (1.2 mm×0.8 mm).

Referring to FIG. 16B, an array resistor 300a may have a structure that uses only a front surface 312 of a hexahedron body 310 to dispose first and second resistors 320 and 330. In this case, all of first and second resistor units 324 and 334 may be disposed on the front surface 312 of the body 310. If the first and second resistors 320 and 330 have a width of about 0.3 mm, one side of the body 310 may have a length of about 0.6 mm and another side of the body 310 may have a length of about 1.8 mm. Thus, the front surface 312 may have an area S6 of about 1.08 mm² (0.6 mm×1.8 mm).

As described above, with respect to FIGS. 1-8D, the first resistor units 324 and the second resistor units 334 may be coated with first and second passivation layers 342, 352, respectively. The first and second passivation layers 342, 352 may be applied to the resistor units 324, 334 before the notches 325, 335 are formed so that the first and second passivation layers 342, 352 may include notches corresponding to the notches 325, 335. First and second resistor unit passivation layers 344, 354 may be formed on the first and second passivation layers 342, 352, respectively.

As described with reference to FIGS. 16A and 16B, the array resistor 300 that uses all the surfaces of the body 310 to dispose the first and second resistors 320 and 330, can have a smaller size than the array resistor 300a that uses only some surfaces of the body 310 to dispose the first and second resistors 320 and 330. Accordingly, the array resistor 300 according to the embodiment of the present general inventive concept can have a higher integration density than the array resistor 300a of FIG. 16B.

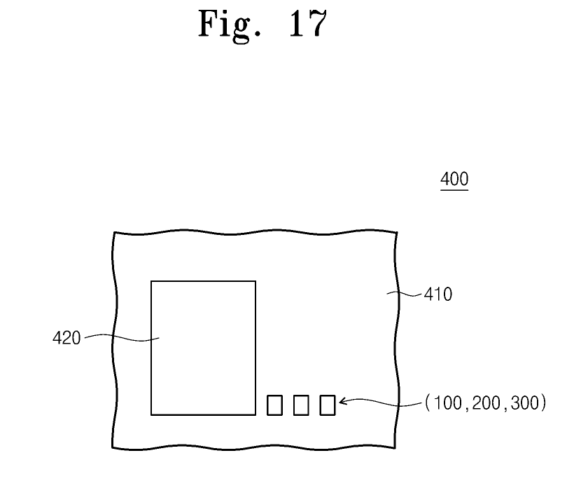

FIG. 17 is a diagram illustrating an electronic device according to an embodiment of the present general inventive concept.

Referring to FIG. 17, the array resistors 100, 200 and 300 according to the above embodiments of the present general inventive concept may be provided in an external unit to form various electronic devices. For example, the array resistors 100, 200 and 300 according to the above embodiments of the present general inventive concept may be provided in an external unit 410 to form an electronic device 400. The electronic unit 400 may further include a semiconductor integrated circuit (IC) chip 420 disposed on the external unit 410. The external unit 410 may include a printed circuit board (PCB). In this case, the array resisters 100, 200 and 300 may be mounted on the external unit 410 in such a way that they are electrically connected to an output terminal of the semiconductor IC chip 420. The electronic device 400 can reduce a noise of a signal wave reflected from the external unit 410 and the semiconductor IC chip 420.

As illustrated in the above FIGS. a main portion or a connection portion of the electrodes, for example, electrodes 122a, 122b of FIGS. 1-3, may extend over an entire surface of a side of the body. Portions of the electrodes may also extend onto adjacent sides. For example, although the main portion of the electrode 122a is located on a side surface 118 of the body 110, a portion of the electrode 122a may extend onto the front side 112 to electrically connect to the first resistor unit 124, and a portion of the electrode 122a may extend onto the rear surface for structural stability or design preference. However, the portions of the electrode that extend onto the front and rear surfaces may only connect the electrode to a resistor unit or affix the electrode to the body, and these portions of the electrode may be too small to connect to external devices. Thus, unless otherwise specified in the specification or claims, when an electrode is described on a surface of the body, the specification and claims refer to the main portion of the electrode that is capable of connecting to an external device or lead and not to the small portions that may connect to a resistor unit or affix the electrode to the body.

In addition, while the above FIGS. may illustrate resistor units that extend over only a portion of surfaces of the array body, the resistor units may also be designed to extend across an entire surface of the body, and may further extend onto adjacent side surfaces. Likewise, the electrodes may extend over only portions of surfaces of the array body, or the electrodes may extend across entire surfaces of the array body.

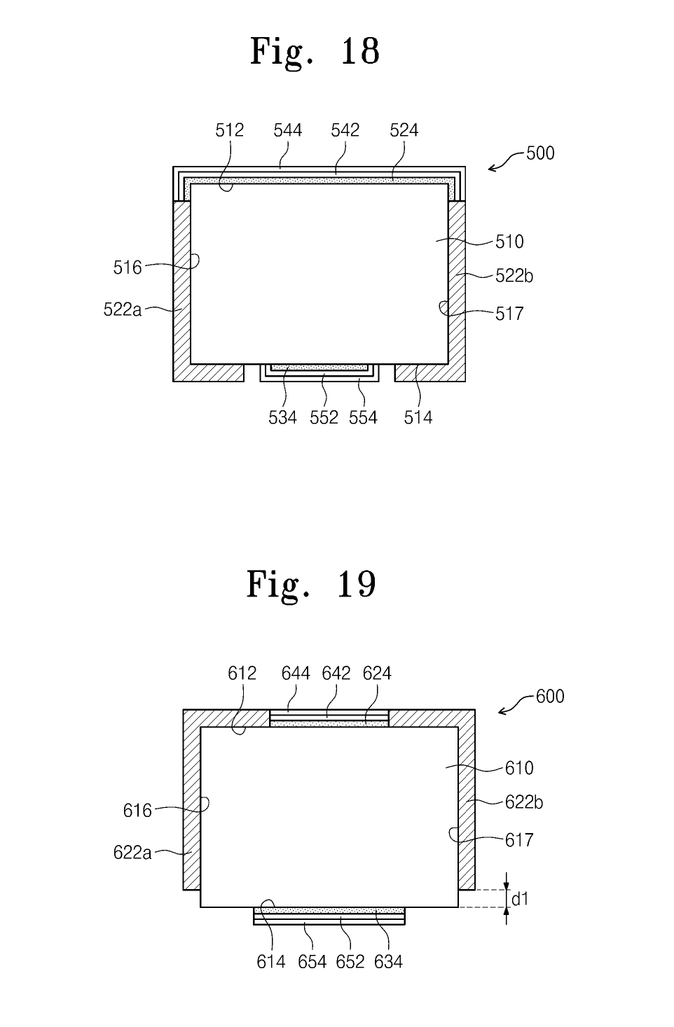

FIG. 18 is a cross-sectional view of an array resistor 500 having a first resistor unit 424 extending across an entire surface of the front surface 512 and onto the adjacent second and third surfaces 516, 517. The first input electrode 522a and first output electrode 522b connect to the first resistor unit 524 on the side surfaces 516, 517 respectively. The body 510, second resistor unit 534, passivation layers 542, 544, 552, 554 and rear side 514 are described above in detail with respect to the array resistors 100, 200, and 300 of all of FIGS. 1-15 and the description will not be repeated here.

FIG. 19 illustrates a cross-sectional view of an array resistor 600 having a first input electrode 622a and a first output electrode 622b that do not extend across an entire surface of the first and second sides 616, 617, respectively. Instead, and end of the electrodes 622a, 622b may terminate a predetermined distance dl from a corner of the side surfaces 616, 617 and the rear surface 614. The array body 610, first and second resistor units 624, 634, passivation layers 642, 644, 652, 654, and front surface 612 are described in detail above with respect to all of FIGS. 1-15 and the description will not be repeated here.

As described above, the array resistor according to the embodiments of the present general inventive concept has a structure that uses all the surfaces of a hexahedron body to dispose a plurality of resistors. Accordingly, the use of the present general inventive concept makes it possible to provide an array resistor with an increased integration density.

Also, the array resistor fabrication method according to the embodiments of the present general inventive concept makes it possible to fabricate an array resistor having a structure that uses all the surfaces of a hexahedron body to dispose a plurality of resistors. Accordingly, the use of the present general inventive concept makes it possible to fabricate an array resistor with an improved integration density.

The above-disclosed subject matter is to be considered illustrative and not restrictive, and the appended claims are intended to cover all such modifications, enhancements, and other embodiments, which fall within the true spirit and scope of the present general inventive concept. Thus, to the maximum extent allowed by law, the scope of the present general inventive concept is to be determined by the broadest permissible interpretation of the following claims and their equivalents, and shall not be restricted or limited by the foregoing detailed description.

For example, while the above embodiments illustrate a resistor array, any appropriate passive electrical component may be used, or any combination of passive electrical components may be used. A passive electrical component may be an electrical component that does not generate power gain, such as a resistor, capacitor, inductor, a two-electrode diode, or other passive components.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. An array resistor comprising:
a body having a front surface, a rear surface opposite to the front surface, and side surfaces connecting the front surface and the rear surface;
a first resistor disposed on the front surface, the first side surface, and the second side surface opposite to the first side surface; and
a second resistor disposed on the rear surface, the third side surface, and the fourth side surface opposite to the third side surface.

2. The array resistor of claim 1, wherein the first resistor includes a first input electrode disposed on the first side surface, a first output electrode disposed on the second side surface, and a first resistor unit disposed on the front surface to connect the first input electrode and the first output electrode; and
wherein the second resistor includes a second input electrode disposed on the third side surface, a second output electrode disposed on the fourth side surface, and a second resistor unit disposed on the rear surface to connect the second input electrode and the second output electrode.

3. The array resistor of claim 1, wherein the body is a single substrate formed of aluminum oxide (Al₂O₃).

4. The array resistor of claim 2, wherein the first resistor unit and the second resistor are disposed to be perpendicular to each other.

5. The array resistor of claim 2, wherein each of the first and second resistor units includes a notch to adjust the resistance value of each of the first and second resistor units.

6. The array resistor of claim 2, wherein the first resistor further includes a glass layer covering the first resistor unit, and the second resistor further includes a glass layer covering the second resistor unit.

7.-11. (canceled)

12. An array resistor, comprising:
a body having a front surface, a rear surface opposite the front surface, and side surfaces connecting the front and rear surfaces;
a first resistor extending across the front surface and onto two side surfaces adjacent to the front surface and opposite each other; and
a second resistor extending across a first surface of the front surface, the rear surface, or one of the side surfaces and onto two surfaces adjacent to the first surface and opposite each other.

13. The array resistor according to claim 12, wherein the first surface is the front surface and the second resistor extends onto two side surfaces adjacent to the front surface and opposite each other.

14. The array resistor according to claim 12, wherein the first surface is the rear surface and the second resistor extends onto two side surfaces adjacent to the rear surface and opposite each other.

15. The array resistor according to claim 12, wherein the first surface is one of the side surfaces and the second resistor extends onto the front surface and the rear surface.

16. The array resistor according to claim 12, wherein:
the first resistor includes a first resistive portion connected between first and second electrodes;
the second resistor includes a second resistive portion connected between third and fourth electrodes;
the first resistive portion of the first resistor is located on the front surface;
the first and second electrodes are respectively located on the two sides adjacent to the front surface and opposite each other;
the second resistive portion of the second resistor is located on the first surface; and
the third and fourth electrodes are respectively located on the two sides adjacent to the first surface and opposite each other.

17. The array resistor according to claim 16, wherein at least one of the first and second resistive portions includes a notch.

18. The array resistor according to claim 16, further comprising:
a first passivation layer on the first resistive portion and a second passivation layer on the second resistive portion.

19. The array resistor according to claim 18, wherein:
at least one of the first and second resistive portions includes a notch; and
the at least one corresponding first and second passivation layer also includes a notch corresponding to the notch of the at least one of the first and second resistive portions.

20. The array resistor according to claim 19, further comprising a third passivation layer located on the first passivation layer; and
a fourth passivation layer located on the second passivation layer,
wherein the third and fourth passivation layers do not include a notch.

21. The array resistor according to claim 12, wherein at least one of the first and second resistors comprises at least two resistors positioned adjacent to each other on a same surface and extending onto same surfaces.

22. A passive electrical component array, comprising:
a body having a front surface, a rear surface opposite the front surface, and side surfaces connecting the front and rear surfaces;
a first passive electrical component extending across the front surface and onto two side surfaces adjacent to the front surface and opposite each other; and
a second passive electrical component extending across a first surface being one of the front surface, the rear surface, or one of the side surfaces and onto two surfaces adjacent to the first surface and opposite each other.

23. The passive electrical component array according to claim 22, wherein at least one of the first and second passive electrical components is a resistor, a capacitor, an inductor, or a diode.

24. The passive electrical component array according to claim 22, wherein:
the first passive electrical component includes a first passive electrical portion connected between first and second electrodes;
the second passive electrical component includes a second passive electrical portion connected between third and fourth electrodes;
the first passive electrical portion of the first resistor is located on the front surface;
the first and second electrodes are respectively located on the two sides adjacent to the front surface and opposite each other;
the second passive electrical portion of the second resistor is located on the first surface; and
the third and fourth electrodes are respectively located on the two sides adjacent to the first surface and opposite each other.

25. The passive electrical component array according to claim 24, wherein at least one of the first and second passive electrical portions includes a notch.

26.-37. (canceled)
